(19) United States
(12) Patent Application Publication
(10) Pub. No.: US 2024/0018965 A1
(43) Pub. Date: Jan. 18, 2024

(54) AXIAL FAN

(71) Applicant: SANYO DENKI CO., LTD., Tokyo (JP)

(72) Inventor: Yoshihisa YAMAZAKI, Tokyo (JP)

(21) Appl. No.: 18/330,431

(22) Filed: Jun. 7, 2023

(30) Foreign Application Priority Data
Jul. 13, 2022 (JP) 2022-112333

(51) Int. Cl. F04D 19/00; F04D 25/06; F04D 29/54

(52) U.S. Cl. CPC F04D 19/002; F04D 25/06; F04D 29/541

(57) ABSTRACT

Provided is an axial fan including: an impeller cup; a fan extending in a radial direction from the impeller cup; a motor inside the impeller cup; and a base portion to which the motor is attached. An outer peripheral portion of the base portion is provided with an outer peripheral wall portion extending in an air-blowing direction. The outer peripheral wall portion includes an upstream end being an end on an upstream side in the air-blowing direction, and a downstream end being an end on a downstream side in the air-blowing direction. The upstream end is located inward in the radial direction relative to an outer peripheral side surface of the impeller cup. The downstream end is located outward in the radial direction relative to the upstream end.

### CROSS-REFERENCE TO RELATED APPLICATION

This application is based on Japanese Patent Application No. 2022-112333 filed with the Japan Patent Office on Jul. 13, 2022, the entire content of which is hereby incorporated by reference.

### BACKGROUND

### 1. Technical Field

One aspect of the present disclosure relates to an axial fan.

### 2. Related Art

An axial fan disclosed in Japanese Patent No. 4943817 realizes noise reduction by forming the flow of air parallel to a rotating shaft in a plane including the rotating shaft while maintaining static pressure.

### SUMMARY

An axial fan includes: an impeller cup; a fan extending in a radial direction from the impeller cup; a motor inside the impeller cup; and a base portion to which the motor is attached. An outer peripheral portion of the base portion is provided with an outer peripheral wall portion extending in an air-blowing direction. The outer peripheral wall portion includes an upstream end being an end on an upstream side in the air-blowing direction, and a downstream end being an end on a downstream side in the air-blowing direction. The upstream end is located inward in the radial direction relative to an outer peripheral side surface of the impeller cup. The downstream end is located outward in the radial direction relative to the upstream end.

### BRIEF DESCRIPTION OF THE DRAWINGS

FIG. 1 is a perspective view of an axial fan according to an embodiment of the present disclosure;

FIG. 2 is a half cross-sectional view illustrating the internal structure of the above axial fan;

FIG. 3 is a perspective view illustrating the shape of spokes of the above axial fan; and

FIG. 4 is a half cross-sectional view illustrating an example of an axial fan of a comparative example.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The axial fan of Japanese Patent No. 4943817 includes a hub, and an impeller including a plurality of blades provided on the perimeter of the hub. A straight line linking a point of intersection of a blade rear edge and a blade tip with the center of rotation of the impeller is located downstream in a rotation direction relative to a straight line linking a point of intersection of a blade front edge and a boundary between the hub and the blade with the center of rotation of the impeller. The camber of the blade protruding toward an air intake side increases gradually toward a centrifugal direction of the blade. Consequently, the flow of air parallel to the rotating shaft is formed to enhance noise reduction.

In this manner, Japanese Patent No. 4943817 describes noise reduction made by improving the configuration of the blade of the axial fan. However, Japanese Patent No. 4943817 does not describe noise reduction made by improving the shape of a member other than the blade. Therefore, there is room for improvement in the noise reduction of the axial fan.

Hence, an object of the present disclosure is to provide an axial fan that can restrain generation of an abnormal noise by improving the configuration of a base portion.

An axial fan according to an aspect of the present disclosure (the axial fan) includes: an impeller cup; a fan extending in a radial direction from the impeller cup; a motor inside the impeller cup; and a base portion to which the motor is attached. An outer peripheral portion of the base portion is provided with an outer peripheral wall portion extending in an air-blowing direction. The outer peripheral wall portion includes an upstream end being an end on an upstream side in the air-blowing direction, and a downstream end being an end on a downstream side in the air-blowing direction. The upstream end is located inward in the radial direction relative to an outer peripheral side surface of the impeller cup. The downstream end is located outward in the radial direction relative to the upstream end.

According to the axial fan, it is possible to provide an axial fan that can restrain generation of an abnormal noise by improving the configuration of a base portion.

An embodiment of the present disclosure is described hereinafter with reference to the drawings. Note that descriptions of members having the same reference numerals as members that have already been described in the detailed description are omitted for convenience's sake. Moreover, the dimensions of each member illustrated in the drawings may be different from actual dimensions thereof for the convenience of description.

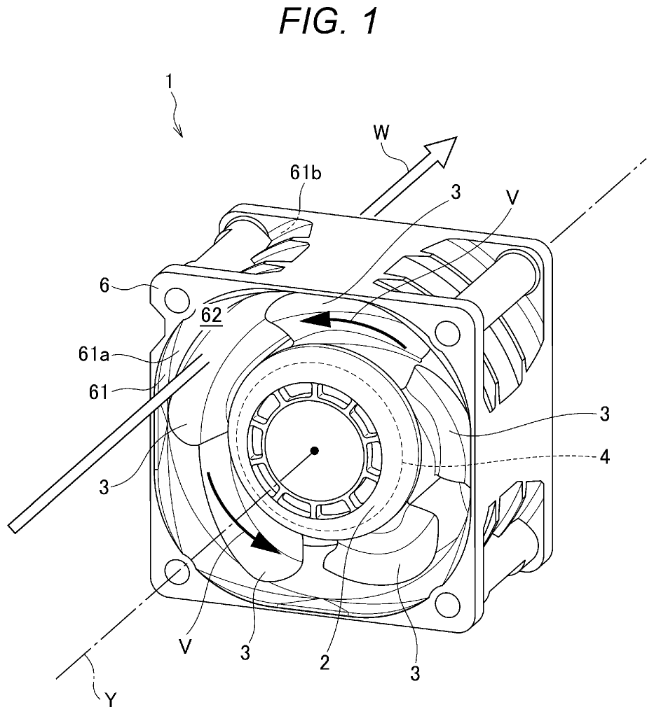

FIG. 1 is a perspective view illustrating an example of an axial fan according to the embodiment of the present disclosure. As illustrated in FIG. 1, an axial fan 1 includes an impeller cup (hub portion) 2, a plurality of rotor blades 3 (an example of a fan) attached to the impeller cup 2, a motor 4 provided inside the impeller cup 2, and a housing 6 that houses the impeller cup 2, the rotor blades 3, and the motor 4.

The entire housing 6 is formed in such a manner as to have a substantially rectangular shape. The housing 6 includes a cylindrical frame portion 61 that surrounds the periphery of the rotor blades 3. The frame portion 61 includes an inlet 61a that takes in air, and an outlet 61b that discharges the taken-in air. The frame portion 61 forms an airway 62 that causes the inlet 61a and the outlet 61b to communicate with each other. The wind taken in from the inlet 61a with the rotation of the rotor blades 3 is sent in an air-blowing direction W indicated by an arrow along the airway 62, and discharged from the outlet 61b to the outside. Arrows V illustrated in the drawings indicate a rotation direction of the rotor blades 3.

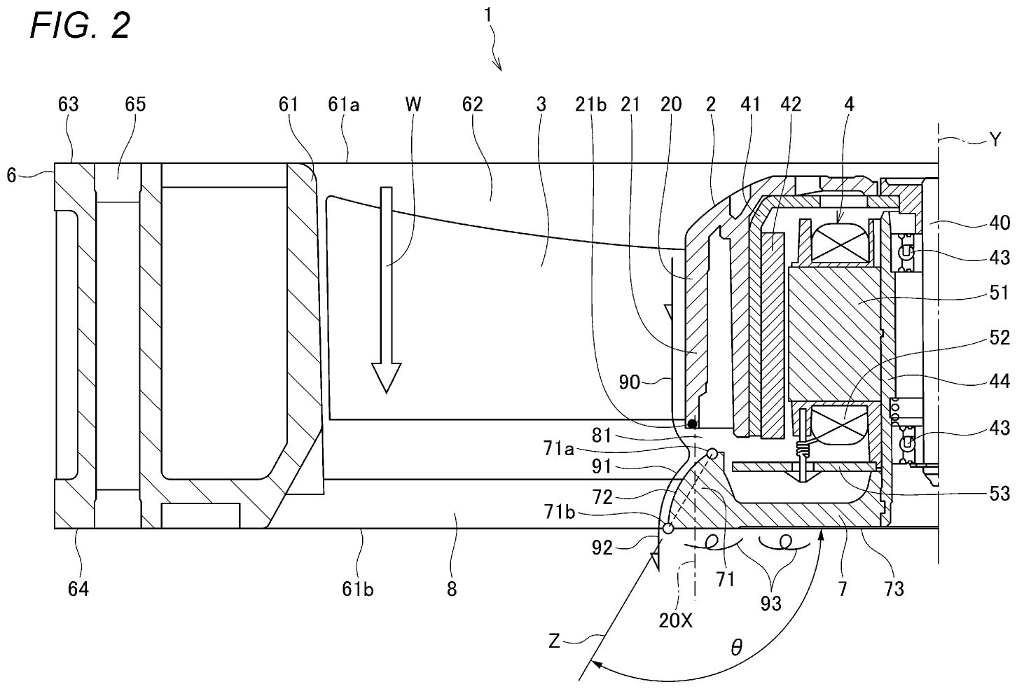

FIG. 2 is a half cross-sectional view illustrating an example of the internal structure of the axial fan 1. FIG. 2 illustrates a half cross-sectional view of the axial fan 1 in a plane passing an axis Y of rotation of the axial fan 1 and a corner of the housing 6. As illustrated in FIGS. 2 and 1, the impeller cup 2 is fixed to a rotating shaft 40 of the motor 4. The rotating shaft 40 is provided in the center of the airway 62 along the airway 62. The rotating shaft 40 is provided in such a manner that a direction of the axis Y thereof is aligned with the air-blowing direction W. The impeller cup 2 is fixed to the rotating shaft 40 in such a manner as to be along the airway 62 with an opening side of the cup facing in a direction of the outlet 61b of the airway 62. An outer peripheral side surface 20, which is on an outer side in a radial direction, of the impeller cup 2 forms an inner peripheral surface of the airway 62 on the inlet 61a side. The outer peripheral side surface 20 of the impeller cup 2 is a surface formed in such a manner as to extend parallel to the air-blowing direction W. The impeller cup 2 to which the rotor blades 3 are attached rotates together with the rotating shaft 40 in the airway 62 to send wind in the air-blowing direction W.

The plurality of rotor blades 3 extends in the radial direction from the impeller cup 2. In other words, the plurality of rotor blades 3 is radially attached to the perimeter of the impeller cup 2, integrally with the impeller cup 2. Each of the plurality of rotor blades 3 is provided in such a manner as to be inclined relative to an axial direction of the rotating shaft 40.

The motor 4 is housed in the impeller cup 2, as a device that rotationally drives the rotor blades 3. The motor 4 includes a substantially cup-shaped rotor yoke 41, the rotating shaft 40 press-fitted in the center of the rotor yoke 41, and a stator core 51 on which a coil 52 is wound.

The rotor yoke 41 is fitted in the impeller cup 2. A magnet 42 is attached to an inner surface of the rotor yoke 41.

The rotating shaft 40 is rotatably supported by a bearing 43. The bearing 43 is fixed to an inner surface of a tubular support portion 44. The stator core 51 is fixed to an outer surface of the support portion 44. An outer surface of the stator core 51 faces an inner surface of the magnet 42 of the rotor yoke 41 with a gap therebetween.

Moreover, as illustrated in FIG. 2, the axial fan 1 includes a base portion 7 to which the stator core 51 of the motor 4 is attached. The base portion 7 is provided at the outlet 61b of the airway 62 in such a manner as to face the opening side of the impeller cup 2. The base portion 7 is formed in a substantially disk shape. The base portion 7 is provided coaxially with the airway 62 in the center of the airway 62. The center of the base portion 7 is fixed to the outer surface of the support portion 44.

Moreover, a circuit board 53 that controls the motor 4 is attached to the base portion 7. The circuit board 53 is attached to the base portion 7 in such a manner as to face the stator core 51. The circuit board 53 is electrically connected to the coil 52 wound on the stator core 51.

An outer peripheral portion of the base portion 7 is provided with an outer peripheral wall portion 71 extending along the air-blowing direction W. The outer peripheral wall portion 71 of the base portion 7 forms an inner peripheral surface of the airway 62 on the outlet 61b side. The outer peripheral wall portion 71 includes an upstream end 71a being an end on the upstream side in the air-blowing direction W, and a downstream end 71b being an end on the downstream side in the air-blowing direction W.

The upstream end 71a of the outer peripheral wall portion 71 is located at the same position in the radial direction as a position 20x of the outer peripheral side surface 20 of the impeller cup 2, or is located inward in the radial direction relative to the position 20x of the outer peripheral side surface 20. The downstream end 71b of the outer peripheral wall portion 71 is located outward in the radial direction relative to the position of the upstream end 71a.

In the example illustrated in the drawing, the upstream end 71a of the outer peripheral wall portion 71 is provided in such a manner as to be located inward in the radial direction relative to the position 20x of the outer peripheral side surface 20 of the impeller cup 2. Moreover, the downstream end 71b of the outer peripheral wall portion 71 is provided in such a manner as to be located outward in the radial direction relative to the position 20x of the outer peripheral side surface 20 of the impeller cup 2. In other words, the upstream end 71a of the outer peripheral wall portion 71 of the base portion 7 is placed in such a manner as to be hidden by the impeller cup 2 from view when the base portion 7 is viewed along the air-blowing direction W from the inlet 61a of the airway 62 via the impeller cup 2. Contrarily, the downstream end 71b of the outer peripheral wall portion 71 is placed in such a manner as to be visible without being hidden by the impeller cup 2 also when the base portion 7 is viewed as described above.

The outer peripheral wall portion 71 is formed in such a manner as to be a downward slope from the upstream end 71a to the downstream end 71b. The upstream end 71a and the downstream end 71b of the outer peripheral wall portion 71 are connected by a convex curved surface. An outer peripheral side surface 72 connecting the upstream end 71a and the downstream end 71b is the convex curved surface.

Let a virtual line passing through the upstream end 71a and the downstream end 71b of the outer peripheral wall portion 71 be an end connecting line Z, and let a cross section orthogonal to the air-blowing direction W be an orthogonal cross section. In this case, an angle θ of inclination of the outer peripheral wall portion 71, which is an angle formed by the end connecting line Z and the orthogonal cross section, is 110° to 130°. For example, the angle θ of inclination of the outer peripheral wall portion 71, which is an angle formed by the end connecting line Z and an undersurface 73 of the base portion 7, is 110° C. to 130° C. The angle θ of inclination of the outer peripheral wall portion 71 is preferably 120°.

Moreover, letting an outer wall portion of the impeller cup 2 in the radial direction be an outer peripheral wall 21, the upstream end 71a of the outer peripheral wall portion 71 of the base portion 7 is located downstream of the position of a downstream edge 21b of the outer peripheral wall 21 in the air-blowing direction W. A boundary layer between the base portion 7 and the impeller cup 2 is provided with a gap 81.

Moreover, the upstream end 71a of the outer peripheral wall portion 71 is located upstream of the position of the circuit board 53 of the motor 4.

The outer edges of the inlet 61a and the outlet 61b of the frame portion 61 of the housing 6 are provided with flange portions 63 and 64 for fixing the housing 6 to, for example, an electronic apparatus. The flange portions 63 and 64 extend outward in the radial direction of the housing 6 from the inlet 61a and outlet 61b, respectively. A fixing hole 65 is formed in the flange portions 63 and 64 in such a manner as to penetrate the housing 6. The axial fan 1 can be attached to, for example, an electronic apparatus by inserting, for example, a screw into the fixing hole 65.

Moreover, the axial fan 1 includes a plurality of spokes 8 coupling the base portion 7 and the frame portion 61, at the outlet 61b of the housing 6. The plurality of spokes 8 is provided to the base portion 7 at a substantially regular interval in a circumferential direction. The spokes 8 support the base portion 7 to which the motor 4 is attached.

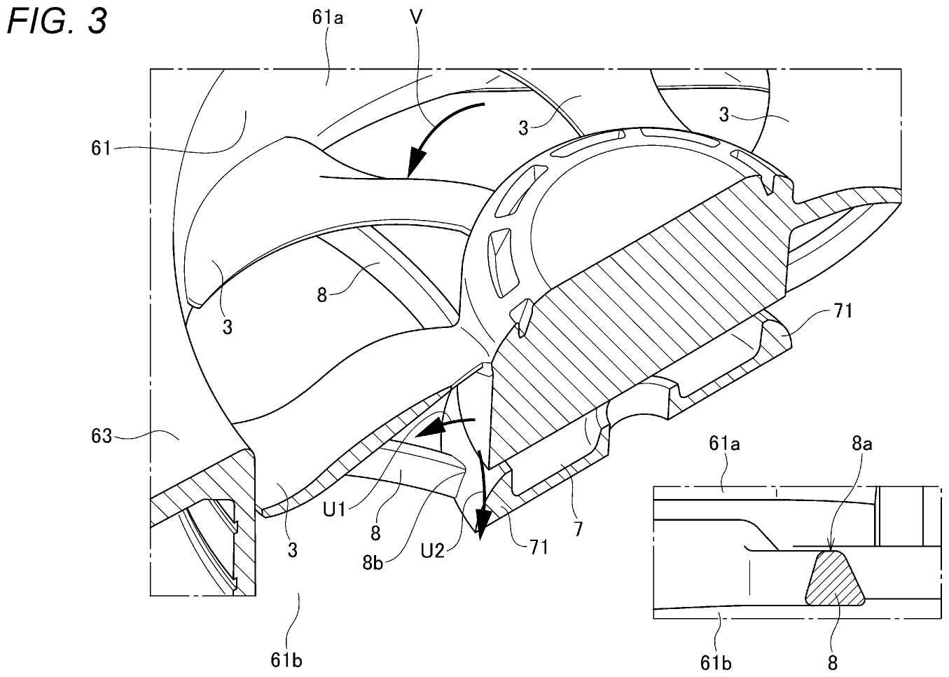

FIG. 3 is a perspective view and cross-sectional view illustrating the spokes 8. Each of the spokes 8 includes a thin rod-like member. An intake-side surface 8a, which is on the inlet 61a side of the airway 62, of the each of the spokes 8 is formed as a convex curved surface.

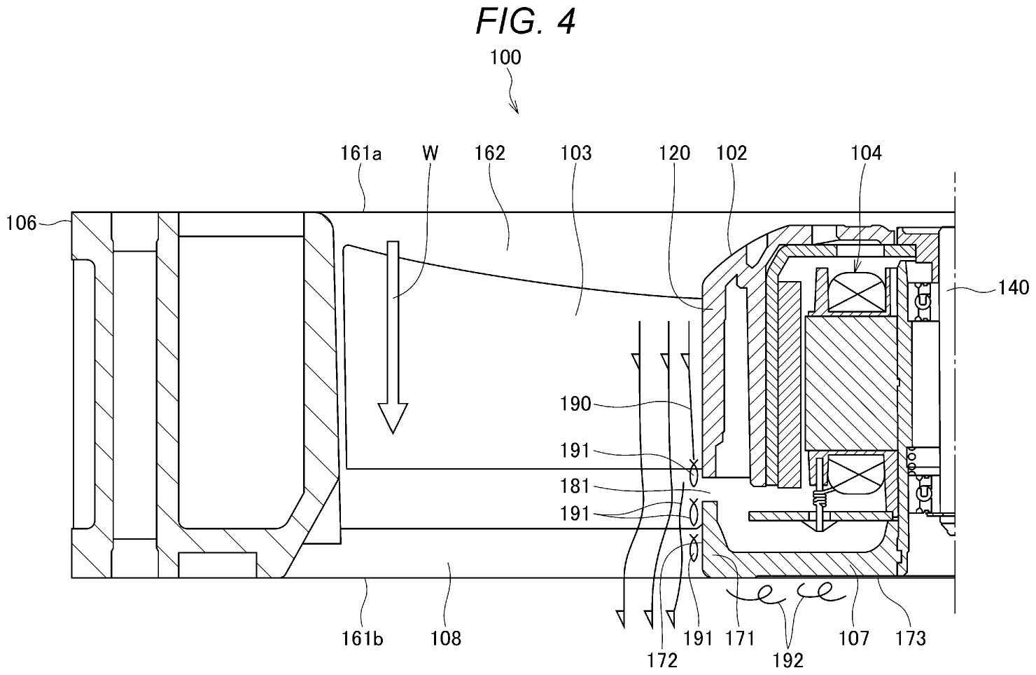

FIG. 4 is a half cross-sectional view illustrating an example of a known axial fan for comparison with the axial fan 1 of the present disclosure. As illustrated in FIG. 4, in a case of a known axial fan 100, an outer peripheral wall portion 171 of a base portion 107 is formed in such a manner that an outer peripheral side surface 172 thereof extends parallel to the air-blowing direction W. Moreover, the outer peripheral wall portion 171 is formed in such as manner as to align the position of the outer peripheral side surface 172 with the position of an outer peripheral side surface 120 of an impeller cup 102 in the radial direction.

Hence, air that flows near the center of an airway 162, for example, air 190 that flows along the outer peripheral side surface 120 of the impeller cup 102, is divided at a gap 181 in a boundary layer between a lower end of the impeller cup 102 and an upper end of the base portion 107. As a result, variations in lift on the outer peripheral side surface 172 increase to generate separated air 191, which is a cause of generation of an abnormal noise.

Moreover, the air 191 separated at the gap 181 flows along the outer peripheral side surface 172 of the base portion 107. Hence, a difference between the velocity of flow of the air 191 flowing along the outer peripheral side surface 172 and the velocity of flow of air 192 flowing along an undersurface 173 of the base portion 107 increases, which is a cause of generation of an abnormal noise.

Furthermore, when the air 191 separated at the gap 181 hits a spoke 108, a direction in which the air 191 flows changes suddenly at a connection portion (a base portion-side joint) between the spoke 108 and the outer peripheral wall portion 171 of the base portion 107, which is a cause of generation of an abnormal noise.

Contrarily, as described above, in the axial fan 1 of the embodiment, the outer peripheral wall portion 71 provided to the outer peripheral portion of the base portion 7 extends along the air-blowing direction W. The upstream end 71a of the outer peripheral wall portion 71 is located inward in the radial direction relative to the outer peripheral side surface 20 of the impeller cup 2. Furthermore, the downstream end 71b of the outer peripheral wall portion 71 is located outward in the radial direction relative to the outer peripheral side surface 20 of the impeller cup 2. Hence, the air flowing along the outer peripheral side surface 20 of the impeller cup 2 hits the downslope outer peripheral side surface 72 that leads from the upstream end 71a to the downstream end 71b of the outer peripheral wall portion 71, and is temporarily decelerated. Furthermore, the air that has hit flows along the downslope outer peripheral side surface 72. Hence, the air can be discharged in the direction of the outlet 61b while the velocity of flow of the air is gradually increased. Consequently, division of air at the gap 81 between the lower end of the impeller cup 2 and the upper end of the base portion 7 can be reduced. Hence, the separation of air flowing near the center of the airway 162 can be reduced. As a result, generation of an abnormal noise can be restrained.

Moreover, according to the axial fan 1, the upstream end 71a and the downstream end 71b of the outer peripheral wall portion 71 are connected by the convex curved surface. Consequently, air 90 flowing along the outer peripheral side surface 20 of the impeller cup 2 hits the outer peripheral side surface 72, which is the convex curved surface, of the outer peripheral wall portion 71, and is decelerated. Hence, air 91 that has hit can be smoothly flowed along the outer peripheral side surface 72 being the convex curved surface. As a result, generation of an abnormal noise can be further restrained. Moreover, the air 91 that has hit flows along the outer peripheral side surface 72 being the convex curved surface, which enables a gradual increase in the velocity of flow of the air 91. Consequently, a difference between the velocity of flow of air 92 discharged from the outlet 61b and the velocity of flow of air 93 flowing along the undersurface 73 of the base portion 7 can be reduced. As a result, fluctuations of the air pressure at the outlet 61b can be reduced. Therefore, generation of an abnormal noise can be restrained. Moreover, the air that has hit flows along the outer peripheral side surface 72 being the convex curved surface, which enables making the flow direction of air along the outer peripheral side surface 72 at the downstream end 71b, that is, the discharge direction of the air 92 discharged from the outlet 61b, substantially the same as the air-blowing direction W. Consequently, a reduction in the volume of air can be suppressed.

Moreover, according to the axial fan 1, the intake-side surface 8a of the each of the spokes 8 that couple the base portion 7 and the frame portion 61 is formed as a convex curved surface. Consequently, as illustrated in, for example, FIG. 3, the air flowing around the connection portion (the base portion-side joint) between the spoke 8 and the outer peripheral wall portion 71 of the base portion 7 can be gently discharged to the outlet 61b as in flows (refer to FIG. 3) represented by arrows U1 and U2. Hence, a difference between the velocity of flow of the air flowing around the spoke 8 at the time of discharge and the velocity of flow of the air 93 flowing along the undersurface 73 of the base portion 7 can be reduced. Accordingly, generation of an abnormal noise can be suppressed.

Moreover, the axial fan 1 is configured in such a manner that the angle θ of inclination formed by the end connecting line Z passing through the upstream end 71a and the downstream end 71b of the outer peripheral wall portion 71 of the base portion 7, and the undersurface 73 of the base portion 7 is 110° to 130°. The angle θ of inclination is set at an angle within this range. Therefore, generation of an abnormal noise can be effectively restrained.

Moreover, according to the axial fan 1, the upstream end 71a of the outer peripheral wall portion 71 is configured in such a manner as to be located downstream of the downstream edge 21b of the impeller cup 2. Consequently, division of the air at the gap 81 between the impeller cup 2 and the base portion 7 can be reduced while the outer peripheral wall portion 71 of the base portion 7 is restrained from obstructing the rotation of the impeller cup 2.

Moreover, according to the axial fan 1, the upstream end 71a of the outer peripheral wall portion 71 is configured in such a manner as to be located upstream of the circuit board 53 of the motor 4. Consequently, division of the air at the gap 81 between the impeller cup 2 and the base portion 7 can be reduced while the circuit board 53 is protected by the outer peripheral wall portion 71 of the base portion 7.

Up to this point the embodiment of the present disclosure has been described. In terms of this, it is needless to say that the technical scope of the present disclosure should not be construed in a limited manner by the detailed description. The embodiment is a mere example. Those skilled in the art understand that the embodiment can be modified in various manners within the technical scope of the present disclosure described in the claims. The technical scope of the present disclosure should be determined based on the scope described in the claims and the scope of equivalents thereof.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An axial fan comprising:
an impeller cup;
a fan extending in a radial direction from the impeller cup;
a motor inside the impeller cup; and
a base portion to which the motor is attached, wherein
an outer peripheral portion of the base portion is provided with an outer peripheral wall portion extending in an air-blowing direction,
the outer peripheral wall portion includes an upstream end being an end on an upstream side in the air-blowing direction, and a downstream end being an end on a downstream side in the air-blowing direction,
the upstream end is located inward in the radial direction relative to an outer peripheral side surface of the impeller cup, and
the downstream end is located outward in the radial direction relative to the upstream end.

2. The axial fan according to claim 1, wherein the downstream end is located outward in the radial direction relative to the outer peripheral side surface of the impeller cup.

3. The axial fan according to claim 1, wherein the upstream end and the downstream end are connected by a convex curved surface.

4. The axial fan according to claim 1, wherein an angle of inclination being an angle formed by a virtual line passing through the upstream end and the downstream end and a cross section orthogonal to the air-blowing direction is 110° to 130°.

5. The axial fan according to claim 1, wherein the upstream end is located downstream of a downstream edge of the impeller cup.

6. The axial fan according to claim 5, wherein the upstream end is located upstream of a board of the motor.
